(19) United States
(12) Patent Application Publication
(10) Pub. No.: US 2006/0061701 A1
(43) Pub. Date: Mar. 23, 2006

(54) PIXEL OF A LIQUID CRYSTAL PANEL, METHOD OF FABRICATING THE SAME AND DRIVING METHOD THEREOF

(76) Inventor: Shih-Chang Chang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,498

(22) Filed: Sep. 22, 2004

(51) Int. Cl. G02F 1/136

(52) U.S. Cl. 349/43

(57) ABSTRACT

A method of fabricating a pixel of a liquid crystal display panel is described. A polysilicon island having an active device region and a storage capacitor region is formed over a first substrate. A bottom electrode is formed by implanting ions into the storage capacitor region of the polysilicon island. A gate-insulating layer is formed over the polysilicon island. A gate and a top electrode are formed over the gate-insulating layer. A source and a drain are formed in the polysilicon island. An insulating layer is formed over the gate-insulating layer. A pixel electrode is formed over the insulating layer and electrically connected with the drain and the bottom electrode. A second substrate having an electrode film thereon is provided. The electrode film and the top electrode are electrically connected to a common electrode. A liquid crystal layer is formed between the first and the second substrate.

### BACKGROUND OF THE INVENTION

1. Field of the Invention

The present invention generally relates to a pixel of a liquid crystal panel, a method of fabricating the same and a method of driving the pixel. More particularly, the present invention relates to a pixel structure of a low temperature polysilicon (LTPS) thin film transistor (TFT) liquid crystal display (LCD) panel, a method of fabricating the same and a method of driving the pixel.

2. Description of the Related Art

Low temperature polysilicon (LTPS) thin film transistors (TFT) are special types of transistors that differ from conventional amorphous silicon TFT. A LTPS TFT has an electron mobility rate of 200 cm²/V-sec or up so that the thin film transistor can be smaller and the aperture ratio can be improved. When the LTPS TFT is used in a display panel, the brightness level of the display panel is higher and the power consumption rate is lower. Furthermore, because of the high electron mobility rate, a portion of driving circuits and the thin film transistors can be fabricated on a glass substrate at the same time, thereby improving the reliability and properties and reducing the production cost of the liquid crystal display panel. In other words, the cost of fabricating a LTPS TFT liquid crystal display panel is significantly lower than the amorphous silicon TFT liquid crystal display panel. With the additional advantages of a small package thickness, a light body and a high display resolution, LTPS TFT liquid crystal display panels are frequently deployed in portable products that demand handiness, low power consumption and portability.

Currently, most liquid crystal display panels are driven by column inversion or line inversion method. However, in the conventional line inversion method, the signal on a data line must undergo a polarity reversal after writing a signal into the pixel. The high voltage amplitude and the high inversion frequency often lead a high power rating and a considerable waste of energy. To reduce power consumption due to line inversion, the driving method must be modified.

### SUMMARY OF THE INVENTION

Accordingly, the present invention is directed to a pixel structure of a liquid crystal display panel adapted to a low power-consuming driving method.

The present invention is directed to a method of fabricating a pixel of a liquid crystal display panel such that the pixel can be driven by a low power-consuming driving method.

The present invention is directed to a method of driving a pixel of a liquid crystal display panel such that overall power consumption of the panel is reduced.

According to an embodiment of the present invention, a method of fabricating a pixel of a liquid crystal display panel is provided. First, a polysilicon layer is formed on a first substrate. The polysilicon layer is patterned to form a polysilicon island. The polysilicon island has an active device region and a storage capacitor region. Thereafter, ions are implanted into the storage capacitor region of the polysilicon island to form a bottom electrode. A gate-insulating layer is formed over the polysilicon island. A gate is formed over the gate-insulating layer within the active device region and a top electrode is formed over the gate-insulating layer within the storage capacitor region. Using the gate as an implant mask, ions are implanted into the active device region of the polysilicon island to form a source and a drain. An insulating layer is formed over the gate-insulating layer covering the gate and the top electrode. A pixel electrode is formed over the insulating layer. The pixel electrode is electrically connected to the drain and the bottom electrode. Thereafter, providing a second substrate and an electrode film is formed over the second substrate. The electrode film formed over the second substrate and the top electrode formed over the first substrate are electrically connected to a common electrode. Finally, a liquid crystal layer is formed between the first substrate and the second substrate.

According to another embodiment of the present invention, a pixel structure of a liquid crystal display panel is provided. The pixel structure comprises a first substrate, a single-type low temperature polysilicon thin film transistor, a pixel electrode, a storage capacitor, a second substrate, an electrode film, a liquid crystal layer and a liquid crystal capacitor. The single-type low temperature polysilicon thin film transistor is disposed on the first substrate. The pixel electrode is disposed on the first substrate and electrically connected to the single-type low temperature polysilicon thin film transistor. The storage capacitor is disposed on the first substrate. One of the terminals of the storage capacitor is electrically connected to the single-type low temperature polysilicon thin film transistor. Furthermore, the storage capacitor is a symmetrical capacitor relative to the single-type low temperature polysilicon thin film transistor. The second substrate is disposed over the first substrate. The electrode film is disposed on the second substrate. The liquid crystal layer is disposed between the first substrate and the second substrate. The liquid crystal capacitor is disposed between the first substrate and the second substrate. One of the terminals of the liquid crystal capacitor is electrically connected to the single-type low temperature polysilicon thin film transistor. The other terminal of the liquid crystal capacitor and the other terminal of the storage capacitor are connected to a common electrode.

The present invention also provides a method of driving a pixel having the aforesaid pixel structure within a liquid crystal display panel. The driving method comprises applying a toggle voltage to the aforementioned common electrode so that a common inversion voltage (Vcom) drives the pixel. The common electrode is electrically connected to one of the terminals of the liquid crystal capacitor and one of the terminals of the storage capacitor.

In the present invention, the pixel structure is driven by a common inversion voltage (Vcom) so that overall power consumption of the panel is reduced. In addition, the gate is used as a self-aligned mask in the fabrication of the source and the drain. Hence, the performance of the thin film transistor is improved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1F are schematic cross-sectional views showing the steps for forming the pixel structure inside a liquid crystal display panel according to one preferred embodiment of the present invention.

FIG. 2 is a schematic cross-sectional view of the pixel structure within a liquid crystal display panel according to one preferred embodiment of the present invention.

FIG. 3 is an equivalent circuit diagram of the pixel structure in FIG. 2.

FIGS. 4A through 4C are schematic cross-sectional views showing the steps for forming the pixel structure of a liquid crystal display panel according to another embodiment of the present invention.

FIG. 5 is a voltage versus time trace for driving the pixel structure according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

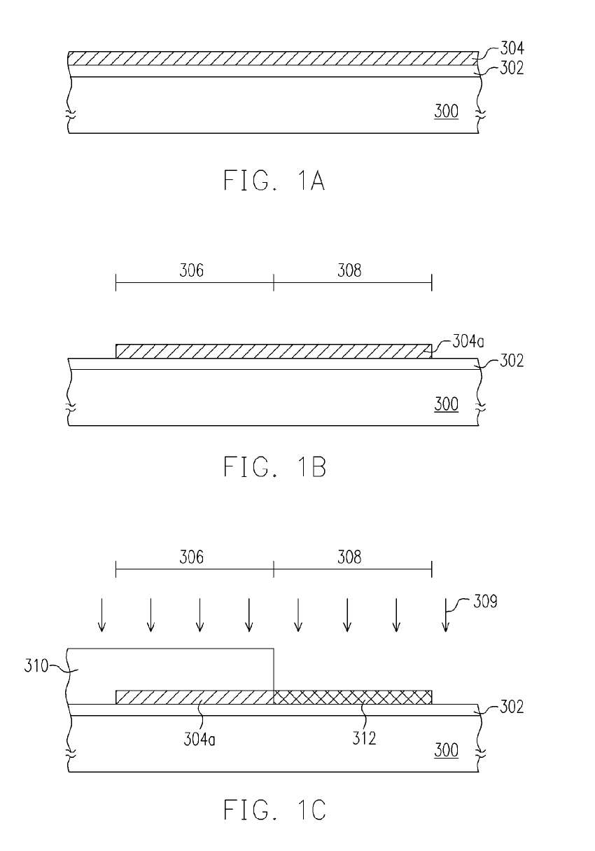

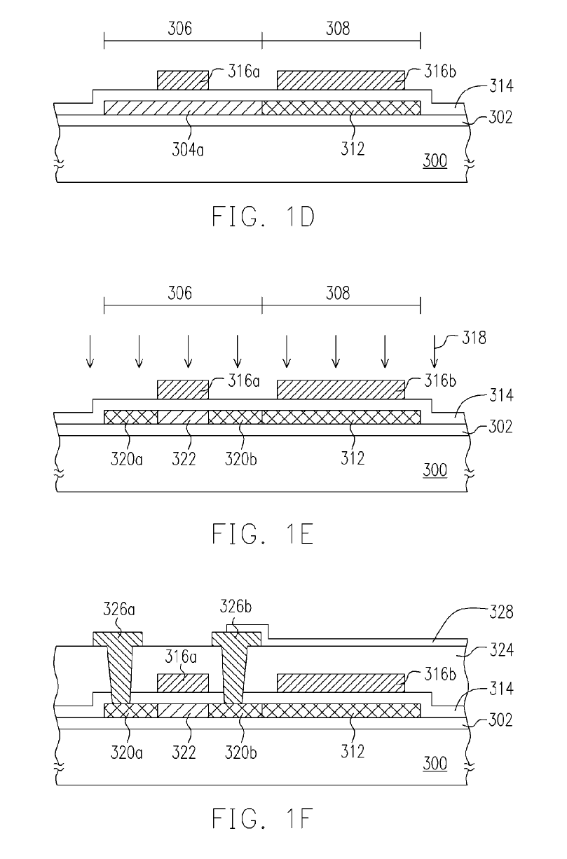

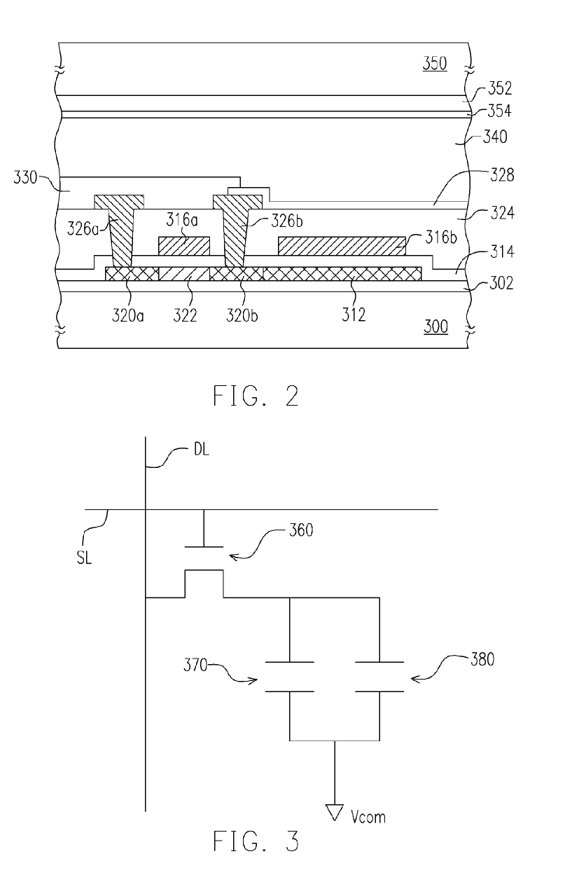

FIGS. 1A through 1F are schematic cross-sectional views showing the steps for forming the pixel structure inside a liquid crystal display panel according to one preferred embodiment of the present invention. FIG. 2 is a schematic cross-sectional view of the pixel structure within a liquid crystal display panel according to one preferred embodiment of the present invention. FIG. 3 is an equivalent circuit diagram of the pixel structure in FIG. 2.

First, as shown in FIG. 1A, a polysilicon layer 304 is formed over a substrate 300. In one preferred embodiment, a buffer layer 302 is formed over the substrate 300 prior to forming the polysilicon layer 304. The polysilicon layer 304 is formed, for example, by depositing an amorphous silicon layer (not shown) and annealing the amorphous silicon layer with a laser beam thereafter.

As shown in FIG. 1B, the polysilicon layer 304 is patterned to form a polysilicon island 304a. The polysilicon island 304a comprises an active device region 306 and a storage capacitor region 308. In one preferred embodiment, the polysilicon island 304a is patterned, for example, by performing photolithographic and etching processes.

As shown in FIG. 1C, ions are implanted into the storage capacitor region 308 of the polysilicon island 304a to form a bottom electrode 312. In one preferred embodiment, the process of implanting ions into the polysilicon island 304a comprises forming a photoresist layer 310 over the substrate 300 to cover the active device region 306 of the polysilicon island 304a. Thereafter, using the photoresist layer 310 as an implant mask, an ion implant operation 309 is carried out to implant N-type or P-type ions into the storage capacitor region 308 of the polysilicon island 304a to form the bottom electrode 312.

As shown in FIG. 1D, the photoresist layer 310 is removed. A gate-insulating layer 314 is formed over the substrate 300 to cover the polysilicon island 304a and the bottom electrode 312. Thereafter, a gate 316a is formed on the gate insulating layer 314 within the active device region 306 and a top electrode 316b is formed over the gate insulating layer 314 within the storage capacitor region 308. Thus, the top electrode 316b, the bottom electrode 312 and the gate-insulating layer 314 between the two electrodes form a storage capacitor 370 as shown in FIG. 3. In the meantime, the scan line SL as shown in FIG. 3 is also defined. In one preferred embodiment, the process of forming the gate 316a, the top electrode 316b and the scan line SL comprises forming a conductive layer over the gate insulating layer 314 and patterning the conductive layer to form the gate 316a, the top electrode 316b and the scan line SL.

As shown in FIG. 1E, using the gate 316a and the top electrode 316b as an implant mask, an N-type or P-type ion implantation 318 is carried out to form a source 320a and a drain 320b in the active device region 306 of the polysilicon island 304a. Furthermore, the area between the source 320a and the drain 320b form a channel region 322. The gate 316a, the source 320a, the drain 320b and the channel region 322 together form a thin film transistor 360 such as an N-type low temperature polysilicon thin film transistor or a P-type low temperature polysilicon thin film transistor as shown in FIG. 3. The thin film transistor 360 (its drain 320b) is electrically connected to the storage capacitor 370 (the bottom electrode 312).

As shown in FIG. 1F, an insulating layer 324 is formed over the gate insulating layer 314 to cover the gate 316a and the top electrode 316b. Thereafter, a source metallic layer 326a having electrical connection with the source 320a and a drain metallic layer 326b having electrical connection with the drain 320b is formed on the surface of and within the insulating layer 324. The process further comprises patterning out the data line DL that has electrical connection with the source metallic layer 326a as shown in FIG. 3. Thereafter, a pixel electrode 328 having electrical connection with the drain metallic layer 326b is patterned over the insulating layer 324.

As shown in FIG. 2, another insulating layer 330 is formed over the source metallic layer 326a and the drain metallic layer 326b. Furthermore, another substrate 350 is provided. An electrode film 354 is formed over the substrate 350. In one preferred embodiment, a color filter layer 352 is formed over the substrate 350 prior to forming the electrode film 354. The color filter layer 352 comprises a plurality of color filter patterns and a black matrix, for example. The two substrates 350 and 300 each having a number of film layers thereon are joined together and a liquid crystal layer 340 is sandwiched between the two. The pixel electrode 328 on the substrate 300, the electrode file 354 on the substrate 350 and the liquid crystal layer 340 between the two electrodes together form a liquid crystal capacitor 380 as shown in FIG. 3.

One of the terminals (the pixel electrode 328) of the liquid crystal capacitor 380 is electrically connected to the thin film transistor 360 while the other terminal (the electrode film 354) of the liquid crystal capacitor 380 is electrically connected to a common electrode (Vcom). Furthermore, one terminal (the top electrode 316b) of the aforementioned storage capacitor 370 is also electrically connected to the common electrode (Vcom).

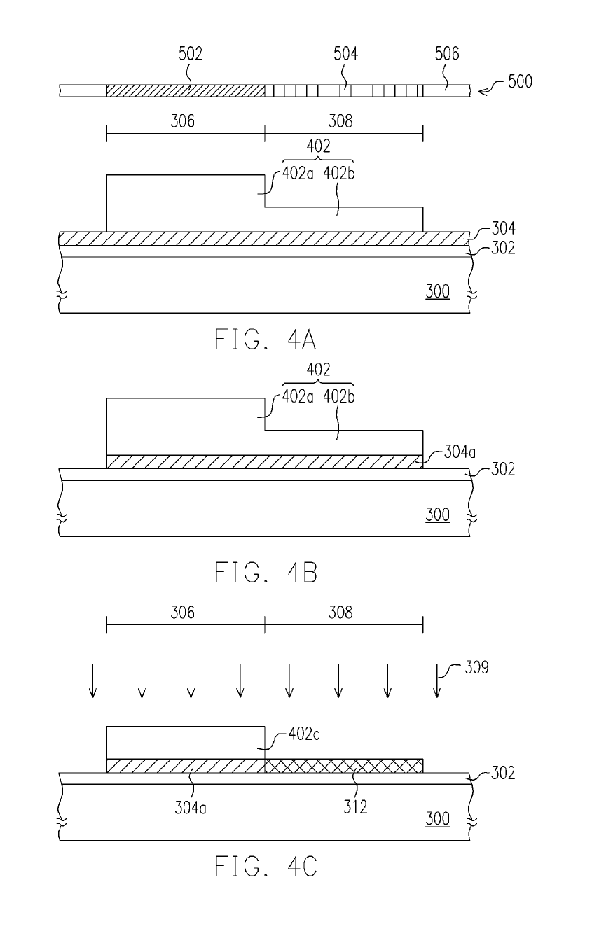

It should be noted that the steps in FIGS. 1B and 1C can be replaced by the steps as shown in FIGS. 4A through 4C. First, as shown in FIG. 4A, after forming a polysilicon layer 304 over the substrate 300, a photoresist layer 402 is formed over the polysilicon layer 304. The photoresist layer 402 has a first portion 402a and a second portion 402b. The first portion 402a covers the active device region 306 while the second portion 402b covers the storage capacitor region 308. Furthermore, the first portion 402a has a thickness greater than the second portion 402b. In one preferred embodiment, the process of forming the photoresist layer 402 comprises performing a photolithographic operation using a special photomask 500. The photomask 500 has a half-tone exposure region 504 corresponding to the storage capacitor region, a non-exposure region 502 corresponding to the active device region 360 and an exposure region 506 corresponding to other regions. Using the photomask 500 to perform the photolithographic operation, a photoresist layer 402 having a first portion 402a and a second portion 402b is formed.

As shown in FIG. 4B, the polysilicon layer 304 is etched using the photoresist layer 402 as a mask to form a plurality of polysilicon islands 304a.

As shown in FIG. 4C, the second portion 402b of the photoresist layer 402 is removed while the first portion 402a covering the active device region 306 is retained. In one preferred embodiment, the second portion 402b of the photoresist layer 402 is removed by performing an ashing operation such as an anisotropic operation using oxygen plasma. Thereafter, using the first portion 402a of the photoresist layer 402 as an implant mask, N-type or P-type ions are implanted into the storage capacitor region 308 within the polysilicon islands 304a to form the bottom electrode 312.

The subsequent steps are identical to the one shown in FIGS. 1D through 1F and 2. However, when the steps in FIGS. 4A to 4C are used to replace steps in FIGS. 1B and 1C, one less masking step is required.

After completing the aforementioned steps, the pixel structure is shown in FIG. 2 and an equivalent circuit diagram of the pixel structure is shown in FIG. 3. As shown in FIGS. 2 and 3, the pixel structure of the liquid crystal panel of the present invention comprises a scan line SL, a data line DL, a P-type or an N-type low temperature polysilicon thin film transistor 360, a storage capacitor 370 and a liquid crystal capacitor 380. The low temperature polysilicon thin film transistor 360 is electrically connected to the scan line SL and the data line DL. One terminal of the storage capacitor 370 is electrically connected to the low temperature polysilicon thin film transistor 360 and one terminal of the liquid crystal capacitor 380 is also electrically connected to the low temperature polysilicon thin film transistor 360. Particularly, the other terminal of the storage capacitor 370 and the other terminal of the liquid crystal capacitor 380 are electrically connected together to a common electrode (Vcom).

In one preferred embodiment, the low temperature polysilicon thin film transistor 360 comprises a gate 316a, a source 320a, a drain 320b and a channel region 322 between the source 320a and the drain 320b. Furthermore, the low temperature polysilicon thin film transistor 360 of the present invention can be a single gate or a dual gate (only single gate is drawn) thin film transistor. The gate 316a is electrically connected to the scan line SL. The source 320a is electrically connected to the data line DL through the source metallic layer 326a and the drain 320b is electrically connected to the pixel electrode 328 through the drain metallic layer 326b. If the thin film transistor 360 is a P-type thin film transistor, the source 320a and the drain 320b are P-doped regions. Conversely, if the thin film transistor 360 is an N-type thin film transistor, the source 320a and the drain 320b are N-doped regions.

In addition, the storage capacitor 370 comprises a top electrode 316b, a bottom electrode 312 and an insulating layer 314 sandwiched between the two. The bottom electrode 312 of the storage capacitor 370 is electrically connected to the drain 320b of the thin film transistor 360. Furthermore, the storage capacitor 370 is regarded as a non-polarized symmetrical capacitor related to the low temperature polysilicon thin film transistor 360. Hence, if the low temperature polysilicon thin film transistor 360 is an N-type transistor, the bottom electrode 312 is an N-doped region. Conversely, if the low temperature polysilicon thin film transistor 360 is a P-type transistor, the bottom electrode 312 is a P-doped region.

Furthermore, one of the electrodes of the liquid crystal capacitor 380 is the pixel electrode 328 while the other electrode of the liquid crystal capacitor 380 is the electrode film 354 on another substrate 350. The liquid crystal layer 340 between the two electrodes is the capacitor dielectric layer. One of the electrodes (the pixel electrode 328) of the liquid crystal capacitor 380 is electrically connected to the drain 320b of the thin film transistor 360. Especially, the top electrode 316b of the storage capacitor 370 and one of the terminals (electrode film 354) of the liquid crystal capacitor 380 are connected together to a common electrode (Vcom).

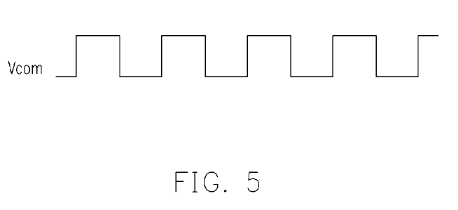

Since the storage capacitor used inside each pixel structure of the present invention is a non-polarized symmetrical capacitor, the pixel structure (as shown in FIGS. 2 and 3) can be driven through a common inversion voltage (Vcom). In other words, a toggle voltage is applied to the common electrode (Vcom) in FIG. 3. The common electrode (Vcom) is electrically connected to one of the terminals of the liquid crystal capacitor 380 and one of the terminals of the storage capacitor 370. The aforementioned toggle voltage has a waveform shown in FIG. 5.

Because the pixel structure of the present invention can be driven by a common inversion voltage (Vcom), overall power consumption of the display panel is reduced. In addition, the gate is used as a self-aligned mask in the process of fabricating the source and the drain. Hence, the performance of the thin film transistor is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of fabricating a pixel structure of a liquid crystal display panel, comprising:
forming a polysilicon layer over a first substrate;
patterning the polysilicon layer to form a polysilicon island, wherein the polysilicon island has an active device region and a storage capacitor region;
implanting ions into the storage capacitor region of the polysilicon island to form a bottom electrode;
forming a gate-insulating layer over the polysilicon island;
forming a gate over the gate insulating layer within the active device region and forming a top electrode over the gate insulating layer within the storage capacitor region;
implanting ions into the active device region of the polysilicon island using the gate as an implant mask to form a source and a drain;
forming an insulating layer over the gate-insulating layer to cover the gate and the top electrode;
forming a pixel electrode over the insulating layer, wherein the pixel electrode is electrically connected to the drain and the bottom electrode;
providing a second substrate;
forming an electrode film over the second substrate, wherein the electrode film and the top electrode are electrically connected to a common electrode; and
forming a liquid crystal layer between the first substrate and the second substrate.

2. The method of claim 1, wherein the step of implanting ions into the storage capacitor region of the polysilicon island to form the bottom electrode comprises:
forming a photoresist layer over the polysilicon island to cover the active device region;
implanting ions into the storage capacitor region of the polysilicon island using the photoresist layer as an implant mask; and
removing the photoresist layer.

3. The method of claim 1, wherein the step of forming the polysilicon island and implanting ions into the storage capacitor region of the polysilicon island to form the bottom electrode comprises:
forming a photoresist layer over the polysilicon layer, wherein the photoresist layer comprises a first portion that covers the active device region and a second portion that covers the storage capacitor region and the first portion has a thickness greater than the second portion;
etching the polysilicon layer using the photoresist layer as a mask to form the polysilicon island;
removing the second portion of the photoresist layer;
implanting ions into the storage capacitor region of the polysilicon island using the first portion of the photoresist layer as a mask; and
removing the photoresist layer.

4. The method of claim 3, wherein the step of forming the photoresist layer comprises performing a photolithographic process using a photomask having a halftone exposure region and a non-exposure region so that the first portion corresponds to the non-exposure region and the second portion corresponds to the halftone exposure region.

5. The method of claim 3, wherein the step of removing the second portion of the photoresist layer comprises performing an ashing process.

6. The method of claim 1, wherein before forming the polysilicon layer, further comprising forming a buffer layer over the substrate.

7. The method of claim 1, wherein before forming the electrode film over the second substrate, further comprising forming a color filter layer on the second substrate.

8. A pixel structure for a liquid crystal display panel, comprising:
a first substrate;
a single-type low temperature polysilicon thin film transistor disposed over the first substrate;
a pixel structure disposed over the first substrate and electrically connected to the single-type low temperature polysilicon thin film transistor;
a storage capacitor disposed over the first substrate, wherein one of the terminals of the storage capacitor is electrically connected to the single-type low temperature polysilicon thin film transistor and the storage capacitor is regarded as a symmetrical capacitor related to the single-type low temperature polysilicon thin film transistor;
a second substrate disposed over the first substrate;
an electrode film disposed on the second substrate;
a liquid crystal layer disposed between the first substrate and the second substrate; and
a liquid crystal capacitor disposed between the first substrate and the second substrate, wherein one of the terminals of the liquid crystal capacitor is electrically connected to the single-type low temperature polysilicon thin film transistor while the other terminal of the liquid crystal capacitor and the other terminal of the storage capacitor are electrically connected to a common electrode.

9. The pixel structure of claim 8, wherein the single-type low temperature polysilicon thin film transistor comprises a P-type low temperature polysilicon thin film transistor.

10. The pixel structure of claim 9, wherein the terminals of the storage capacitor comprises a top electrode and a bottom electrode such that the bottom electrode is a P-doped region.

11. The pixel structure of claim 8, wherein the single-type low temperature polysilicon thin film transistor comprises an N-type low temperature polysilicon thin film transistor.

12. The pixel structure of claim 11, wherein the terminals of the storage capacitor comprises a top electrode and a bottom electrode such that the bottom electrode is an N-doped region.

13. The pixel structure of claim 8, wherein the single-type low temperature polysilicon thin film transistor comprises a single gate low temperature polysilicon thin film transistor or a dual gate low temperature polysilicon thin film transistor.

14. The pixel structure of claim 8, wherein the terminals of the liquid crystal capacitor comprises the electrode film and the pixel electrode.

15. The pixel structure of claim 8, further comprising a color filter layer disposed between the second substrate and the electrode film.

16. A method of driving a pixel having a structure described in claim 8, comprising the step of applying a toggle voltage as a common inversion voltage (Vcom) to the common electrode, wherein the common electrode is electrically connected to one of the terminals of the liquid crystal capacitor as well as one of the terminals of the storage capacitor.
